(19) United States
(12) Patent Application Publication
(10) Pub. No.: US 2026/0208443 A1
(43) Pub. Date: Jul. 23, 2026

(54) DEVICE AND METHOD FOR THE ADDITIVE MANUFACTURE OF A THREE-DIMENSIONAL OBJECT

(71) Applicant: COMPAGNIE GENERALE DES ETABLISSEMENTS MICHELIN, Clermont-Ferrand (FR)

(72) Inventors: THOMAS SIMONELLI, Clermont-Ferrand (FR); CLEMENT NAGODE, Clermont-Ferrand (FR); MICKAEL ROUBY, Clermont-Ferrand (FR)

(21) Appl. No.: 19/138,764

(22) PCT Filed: Nov. 23, 2023
(86) PCT No.: PCT/FR2023/051848

§ 371 Date: Jun. 13, 2025

(30) Foreign Application Priority Data
Dec. 16, 2022 (FR) 2213551

(51) Int. Cl. B29C 64/321; B29C 48/02; B29C 48/255; B29C 48/345; B29C 64/118; B29C 64/209; B29C 64/232; B29C 64/236; B29C 64/245; B29L 30/00; B33Y 10/00; B33Y 30/00; B33Y 80/00

(52) U.S. Cl. CPC B29C 64/321; B29C 48/02; B29C 48/2556; B29C 48/345; B29C 64/118; B29C 64/209; B29C 64/232; B29C 64/236; B29C 64/245; B33Y 10/00; B33Y 30/00; B33Y 80/00; B29L 2030/002

(57) ABSTRACT

A device for additive manufacturing of all or part of a three-dimensional object (106) on a manufacturing support (104) comprising at least one additive material-depositing rail (20, 30) intended to be positioned above the manufacturing support (104), extending along a longitudinal axis (X) and comprising a plurality of material-depositing nozzles each provided with at least one dispensing orifice, each of the material-depositing nozzles comprising closing means movable between a closed position and a plurality of open positions of said dispensing orifice, and an actuator for controlling the movement of the closing means between the closed and open positions, the closing means being controllable independently of each other.

The device comprises at least one actuation system configured to generate a relative translation of the material-depositing rail with respect to the manufacturing support (104) in at least a vertical direction (Z) and/or a longitudinal direction (X).

The present invention relates to the field of manufacturing three-dimensional objects.

It is known practice to produce three-dimensional objects from plastic using plastic injection moulds.

Although such a manufacturing method makes it possible to produce a large number of three-dimensional objects, the prior manufacturing of an injection mould increases the manufacturing time of the three-dimensional object.

Methods for depositing material are also known in which the three-dimensional object is produced by spraying individual droplets that are then photo-cross-linked. However, the generation of individual droplets does not make it possible to obtain a three-dimensional object of satisfactory quality, as the mechanical strength of the parts is insufficient. In addition, the printing time is very long.

In the case of PolyJet material deposition, the problem is especially linked to the choice of materials, which is limited by the requirement that they must be suitable for UV cross-linking.

Additive manufacturing is also known by extrusion of a molten material, referred to as fused deposition modelling, or FDM.

It is known practice to use an extruder in order to produce a string or thread of molten material using filaments or pellets made from a thermoplastic or composite material.

However, current methods are particularly slow as the support is positioned at a given azimuth before the nozzle deposits material and the operation is repeated until the three-dimensional object is completely manufactured. Such a solution only allows the deposition of a few tens of grammes per hour, for example 50 g/hr.

In addition, the slowness of the manufacturing of the tread can result in seepage problems.

Reference can be made in this regard to FR-B1-3 067 281, which proposes a system for manufacturing a tread of a tyre of a tubeless integral wheel. The device comprises a construction robot comprising one or more nozzles for additive material deposition. The nozzles are positioned side by side and able to move laterally so that they can cover the whole tread to be built.

In order to reduce the manufacturing time of the three-dimensional object, large extruders could be provided with 5 mm to 10 mm material-depositing nozzles. However, in this case, although the material deposition rate is higher, of the order of 900 g/hr, the accuracy is significantly reduced.

None of the proposed solutions is therefore satisfactory, as a choice must be made between the speed of manufacturing the three-dimensional object and the quality of the details or geometry of said three dimensional object.

In order to obtain a high material deposition rate while retaining satisfactory quality of the geometry of the three-dimensional object, a large number of extruders could be used, for example between 100 and 200 extruders, each having its own path. However, providing approximately one hundred robot arms each comprising an extruder and arranged around a three-dimensional object cannot be envisaged in terms of space occupied and manufacturing cost.

There is thus a need to improve the devices for manufacturing a three-dimensional object.

The aim of the invention is to manufacture a three-dimensional object quickly while retaining the quality of the details of the three-dimensional object.

The aim is thus to reduce the manufacturing time of a three-dimensional object and thus deposit a large quantity in a short time, of the order of 10 kg/hr.

The present invention relates to a device for the additive manufacturing of all or part of a three-dimensional object on a manufacturing support.

“Additive manufacturing” is given to mean a manufacturing method by means of the addition of extruded material, referred to as fused deposition modelling, or FDM.

The additive manufacturing device comprises at least one additive material-depositing rail suitable for being positioned above the manufacturing support, and comprising a plurality of material-depositing nozzles.

The material-depositing nozzles are each provided with at least one dispensing orifice.

Each of the material-depositing nozzles comprises closing means that can be moved between a closed position and a plurality of open positions of said dispensing orifice, and an actuator for controlling the movement of the closing means between the closed and open positions, the closing means being controllable independently of each other.

Each of the material-depositing nozzles is thus configured to deposit molten material on the manufacturing support, in particular on a receiving surface, in a plurality of material deposition sequences.

“Open position” of said dispensing orifice is given to mean a fully open position of the dispensing orifice, but also the intermediate positions in which the dispensing orifice is partially open.

The opening of the dispensing orifice can advantageously be dependent on the material deposition rate. Controlling the opening of the dispensing orifice makes it possible to manage the material deposition rate by varying the position of the closing means, in particular the needle.

The material-depositing nozzles can be identical to or different from each other in their dimensions, such as the diameter of the dispensing orifice, their height or their outer dimension.

The additive manufacturing device further comprises at least one actuation system configured to generate a relative translation between the material-depositing rail and the manufacturing support in at least a vertical direction and/or a longitudinal direction.

When the material-depositing rail is moved, all of the material-depositing nozzles are thus moved simultaneously, due to the movement of the material-depositing rail.

The dispensing orifices of each of the nozzles can be closed independently of each other and responsively, so that any detail can be manufactured on the circumferential bearing surface of the manufacturing support and in a short time.

The three-dimensional object is manufactured by depositing extruded material layer by layer. The extruded material melts on the previously deposited layer of material and solidifies when the temperature drops.

The longitudinal direction is parallel to the longitudinal axis f the rail or coincident with the longitudinal axis of the rail.

Advantageously, the additive manufacturing device comprises at least one extruder connected to the material-depositing rail and feeding said rail with a thread of molten material.

For example, the extruder is associated with all of the material-depositing nozzles.

For example, the extruder is central. As a variant, a position other than a central position could be envisaged for the extruder.

A single central extruder makes it possible to reduce the space occupied around the manufacturing support, as well as the manufacturing cost.

As a variant, at least one extruder associated with at least one material-depositing nozzle could be provided.

For example, a plurality of extruders could be provided, each associated with at least two material-depositing nozzles.

For example, the thread of molten material can be obtained from pellets.

The pellets of material are for example made from plastic, for example thermoplastic (TP) or thermoplastic elastomer (TPE). The pellets of material are therefore hot extruded.

As a variant, the thread of molten material can be obtained from one or more filaments, or even strips. The thread of molten material can be either fragmented or continuous.

Preferably, the thread of molten material is continuous and not in the form of successive droplets in order to avoid any defects in the geometry of the object.

Advantageously, each material-depositing nozzle comprises a chamber for receiving molten material coming from the extruder communicating with the dispensing orifice.

The dispensing orifice has, for example, a dimension of between 0.6 mm and 1.5 mm, preferably between 0.6 mm and 0.8 mm for producing a material deposit 1 mm wide, and preferably between 1 mm and 1.5 mm for producing a material deposit 2 mm wide.

For example, the dispensing orifice of each of the material-depositing nozzles has a rectangular or circular cross-section. A rectangular cross-section makes it possible to improve the level of detail of the geometry of the three-dimensional object and the quality of the interruptions by the closing means.

For example, the additive manufacturing device comprises a fixed stand and one or more material-depositing rails translatably mounted relative to said fixed stand.

For example, the additive manufacturing device comprises at least two material-depositing rails each associated with a dedicated actuation system and arranged in two given transverse positions above the manufacturing support.

The closing frequency of the temporary closing means is, for example, between 10 Hz and 30 Hz, for example equal to 20 Hz.

According to one embodiment, each of the temporary closing means comprises a needle.

As a variant, other closing means could be provided, such as for example a slide closing means or any other type of closing means configured to close or open the dispensing orifice.

The actuator comprises, for example, a piezoelectric device for closing or opening the dispensing orifice of the corresponding nozzle.

The use of a pneumatic, magnetic, electric or hydraulic cylinder could also be envisaged for closing or opening the dispensing orifice of the corresponding nozzle.

The needle closing means make it possible to produce clean stoppages of the flow of molten material, without burrs, and clear resumptions of said flow. As a variant, any other closing system associated with each of the nozzles could be provided, such as a valve for example.

The additive manufacturing device can comprise a volumetric metering device positioned downstream of the extruder and upstream of the material-depositing rail. For example, the volumetric metering device is a gear pump. The volumetric metering device is configured to deliver a calibrated quantity of molten material onto the bearing surface of the manufacturing support. Lines of material having a constant width can thus be obtained.

The volumetric metering device makes it possible to control the quantity of extruded material deposited, repeatably throughout the manufacturing of the object. Controlling the quantity of extruded material also makes it possible to limit wastage of material not necessary for the manufacturing of the object.

According to one embodiment, at least one of the material-depositing nozzles is configured to deposit material on all of the thicknesses of at least one transverse line of material.

Depositing material in a “line of material” is given to mean depositing material on the bearing surface of the manufacturing support along an axis perpendicular to the longitudinal axis, for example the transverse axis if the object to be manufactured is parallelepipedal, or a circular path if the object to be manufactured is cylindrical.

“Thickness” is given to mean a stratum of material deposited on a transverse or circular line of material.

According to one embodiment, the material-depositing nozzles are arranged on the material-depositing rail in a single row in the longitudinal direction.

In this instance, all of the material-depositing nozzles are configured to deposit a layer of material during a material deposition sequence, optionally during a movement of the receiving support in a working direction, and said material-depositing rail is configured to undergo a relative translation along the vertical axis after each deposit of a layer of material.

“Working direction” is given to mean the transverse direction if the object to be manufactured is a parallelepiped or a shape other than cylindrical, or a rotation about the longitudinal axis if the object to be manufactured is cylindrical.

Generally, the working direction of the manufacturing support is perpendicular to the axis of extension, for example longitudinal, of the rail.

Each of the material-depositing nozzles is thus configured to deposit molten material in a corresponding line of material, corresponding to a material deposition sequence, and after each material deposition sequence, that is, after the manufacturing of each layer of material, said material-depositing rail is configured to undergo a relative translation along the vertical axis with respect to the manufacturing support, and so on until the desired three-dimensional object is obtained.

“Layer of material” is given to mean all of the lines of material side by side over the entire width of the three-dimensional object to be manufactured. A layer of material corresponds to a thickness of deposited molten material. On a layer of material, provision could be made for material not to be deposited on one or more lines in order to produce a particular geometric shape of the object to be manufactured.

If the object to be manufactured is cylindrical, a layer corresponds to all of the circumferential lines.

As a variant, if the object to be manufactured is parallelepipedal or generally a non-cylindrical shape, a layer corresponds to all of the transverse lines.

“Row” is given to mean an arrangement along the longitudinal axis. A row is positioned across the width of the object to be manufactured.

“Width” of the object to be manufactured is given to mean the dimension along the longitudinal axis. The width could also be the dimension along the transverse axis. Generally, the width of the object to be manufactured corresponds to the dimension of extension of the rail.

The material-depositing rail can be configured to be translated relative to the manufacturing support along the vertical axis. As a variant, the material-depositing rail can be fixed relative to the stand of the manufacturing device, and the manufacturing support is configured to be translated relative to the material-depositing rail along the vertical axis.

According to one embodiment, the additive manufacturing device comprises a member for driving the manufacturing support capable of driving the manufacturing support in a working direction.

According to one embodiment, the material-depositing nozzles are arranged on the material-depositing rail in at least two rows offset along a transverse axis perpendicular to the longitudinal direction and perpendicular to the vertical direction, each row comprising at least two material-depositing nozzles aligned in the longitudinal direction.

In other words, the rows are parallel to each other.

During each material deposition sequence, in particular during a relative movement in the working direction of the material-depositing rail with respect to the manufacturing support, each material-depositing nozzle is configured to deposit molten material over a thickness in at least one given line of material. All of the material-depositing nozzles deposit material in a first layer corresponding to the width of the three-dimensional object to be manufactured.

After each material deposition sequence, that is, after the manufacturing of each layer of material, the transverse position of the manufacturing support is reset and a relative movement along the vertical axis of the material-depositing rail with respect to the manufacturing support is generated in order to move said rail vertically away from said support. Then, each of the material-depositing nozzles is actuated in order to deposit molten material in the same given transverse line of material, in order to form the second layer. These operations are repeated until the desired thickness of the object to be manufactured is obtained. Provision could also be made for the closing means of certain nozzles to be in the closed position in order to produce a particular geometric shape. Again, it can also be envisaged that the position of the manufacturing support not be reset and that material be deposited on the deposited layer of material in the opposite sense.

Again, provision can be made for the material-depositing rail to be able to translate relative to the manufacturing support along the vertical axis or, as a variant, for the manufacturing support to be able to translate relative to the material-depositing rail along the vertical axis.

Generally, the number of rows depends on the width of the three-dimensional object to be manufactured.

According to one embodiment, the width of the material-depositing rail is smaller than the width of the three-dimensional object to be manufactured.

In this instance, during each material deposition sequence, and in particular during the relative movement in the working direction of the material-depositing rail with respect to the manufacturing support, each material-depositing nozzle is configured to deposit material over a thickness in a given line of material, and after each manufacturing of thickness in a given transverse line of material, the material-depositing rail is configured to translate axially relative to the manufacturing support along the longitudinal axis by the width of said rail, as many times as necessary to manufacture the first layer comprising all of the lines of material. These operations are repeated until all of the superposed layers forming the desired thickness of the object to be manufactured are obtained.

According to another variant, provision could be made for the width of the material-depositing rail to be equal to or even greater than the width of the three-dimensional object to be manufactured, but for the density of material-depositing nozzles to be reduced in order to reduce costs. In this instance, after each material deposition sequence, that is, after each nozzle has deposited material in a given line, the material-depositing rail is configured to be axially offset in translation relative to the manufacturing support along the longitudinal axis by the width of a material-depositing nozzle as many times as necessary to produce the first layer comprising all of the lines of material. Again, each material-depositing nozzle is configured to deposit material on a plurality of lines of material during a plurality of material deposition sequences.

According to one embodiment, the material-depositing nozzles are arranged in a single plane containing a longitudinal axis, said nozzles being vertically offset relative to each other.

In this instance, at least one of the material-depositing nozzles can be configured to deposit material on all of the circumferential lines of an entire layer of material during a plurality of material deposition sequences and the material-depositing rail is configured to translate axially only relative to the manufacturing support along the longitudinal axis by a line of material after each material deposition sequence.

This time, the number of material-depositing nozzles depends on the number of layers to be printed.

In this instance, at least one of the material-depositing nozzles of the material-depositing rail is configured to deposit material on a line of material of a first layer of material. After each material deposition sequence, the material-depositing rail is configured to be translated axially only relative to the manufacturing support along the longitudinal axis by a line of material. These operations are repeated until at least one of the material-depositing nozzles deposits material on an entire first layer of material comprising all of the lines of material.

Next, the adjacent nozzle is configured to deposit material on a line of material of a second layer of material superposed on the first layer. These operations are repeated until the desired thickness of the object to be manufactured is obtained.

The nozzles are for example actuated simultaneously in order to deposit material in a line of material on the lower line of material, then the material-depositing rail is configured to translate axially relative to the manufacturing support along the longitudinal axis by a circumferential line of material after each material deposition sequence, so that the material-depositing nozzles manufacture the adjacent line, and so on until the desired geometry of the three-dimensional object is obtained.

According to another embodiment, the device for additive manufacturing of an object comprises two material-depositing rails each associated with a dedicated actuation system, said rails being able to translate in two opposite senses in the longitudinal direction. The two material-depositing rails are configured to deposit a single layer of material together.

According to one embodiment, the device comprises a member for driving the manufacturing support capable of driving the manufacturing support in a working direction.

According to one embodiment, the actuation system is configured to translate the material-depositing rail relative to the manufacturing support in a vertical direction and/or the longitudinal direction.

According to a second aspect, the invention relates to a method for additive manufacturing of all or part of a three-dimensional object on a manufacturing support using a manufacturing device comprising at least one material-depositing rail positioned above the manufacturing support, extending along an axis of extension, here a longitudinal axis, and comprising a plurality of additive material-depositing nozzles each provided with at least one dispensing orifice, wherein:
each of the material-depositing nozzles deposits extruded material on the manufacturing support during a material deposition sequence,
closing means each associated with one of the material-depositing nozzles are controlled independently of each other in order to be moved between a closed position and a plurality of open positions of the dispensing orifice of each nozzle depending on the geometry of the three-dimensional object to be manufactured, and
after each material deposition sequence, the material-depositing rail and the manufacturing support undergo relative translation with respect to each other in at least a vertical direction and/or a longitudinal direction.

According to one embodiment, during each material deposition sequence, the manufacturing support is translated relative to the material-depositing rail along the transverse axis between an initial position and a final position, and returns to its initial position at the end of each material deposition sequence. As a variant, it can also be envisaged that it does not return to the initial position in order to deposit material on the next layer, but starts in the final position of the preceding layer and creates the layer in the opposite sense. This makes it possible to save time and does not require time for returning to the initial position.

During each material deposition sequence, each material-depositing nozzle deposits material over a thickness of at least one given line of material, and all of the material-depositing nozzles deposit material in a first layer corresponding to the width of the three-dimensional object to be manufactured, and after each material deposition sequence, the material-depositing rail is translated relative to the manufacturing support along the vertical axis and each of the material-depositing nozzles deposits material in the same given line of material, in order to form a second layer superposed on the first layer. These operations are repeated until the desired thickness of the three-dimensional object is obtained.

An entire layer is thus produced on each material deposition sequence.

The material-depositing rail can be translated relative to the manufacturing support along the vertical axis. As a variant, the material-depositing rail can be fixed relative to the stand of the manufacturing device, and the manufacturing support is translated relative to the material-depositing rail along the vertical axis.

According to one embodiment, the width of the material-depositing rail is smaller than the width of the tread to be manufactured. During each material deposition sequence, each material-depositing nozzle deposits material over a thickness in a given line of material. Said material-depositing rail is translated axially relative to the tyre along the longitudinal axis by the width of said rail after each material deposition sequence. These operations are repeated until the first layer of material comprising all of the lines of material is obtained.

The material-depositing rail can be translated relative to the manufacturing support along the longitudinal axis. As a variant, the material-depositing rail can be fixed relative to the stand of the manufacturing device, and the manufacturing support is translated relative to the material-depositing rail along the longitudinal axis.

Each material-depositing nozzle thus deposits material on a plurality of lines of material during a plurality of material deposition sequences. Next, the manufacturing support is translated relative to the material-depositing rail along the transverse axis in its initial position and the material-depositing rail is translated vertically relative to the manufacturing support in order to create the second layer, and so on until the desired thickness of the three-dimensional object is obtained.

According to another variant, provision could be made for the width of the material-depositing rail to be equal to or greater than the width of the three-dimensional object to be manufactured, but for the density of material-depositing nozzles to be reduced in order to reduce costs. In this instance, after each material deposition sequence, the material-depositing rail is axially offset in translation relative to the manufacturing support along the longitudinal axis by the width of a material-depositing nozzle as many times as necessary to produce the first layer comprising all of the lines of material. Again, each material-depositing nozzle deposits material on a plurality of lines of material during a plurality of material deposition sequences.

According to another embodiment, in which the width of the material-depositing rail is equal to the width of the three-dimensional object to be manufactured, during each material deposition sequence, at least one of the material-depositing nozzles deposits material on a circumferential line of material of an entire layer of material. After each material deposition sequence, the manufacturing support is translated relative to the material-depositing rail along the transverse axis in its initial position and the material-depositing rail is translated axially only relative to the manufacturing support along the longitudinal axis by a line of material. These operations are repeated until at least one of the material-depositing nozzles deposits material on an entire layer of material comprising all of the lines of material.

This time, the number of material-depositing nozzles depends on the number of layers to be printed.

In this instance, during a material deposition sequence, the nozzles are actuated simultaneously in order to deposit material in a line of material on the lower line of material, then the material-depositing rail is translated axially relative to the manufacturing support along the longitudinal axis by a line of material after each material deposition sequence, so that the material-depositing nozzles deposit material along the adjacent line of material, and so on until the desired three-dimensional object is obtained.

Further aims, features and advantages of the invention will become apparent on reading the following description, which is given solely by way of non-limiting example, and with reference to the appended drawings, in which:

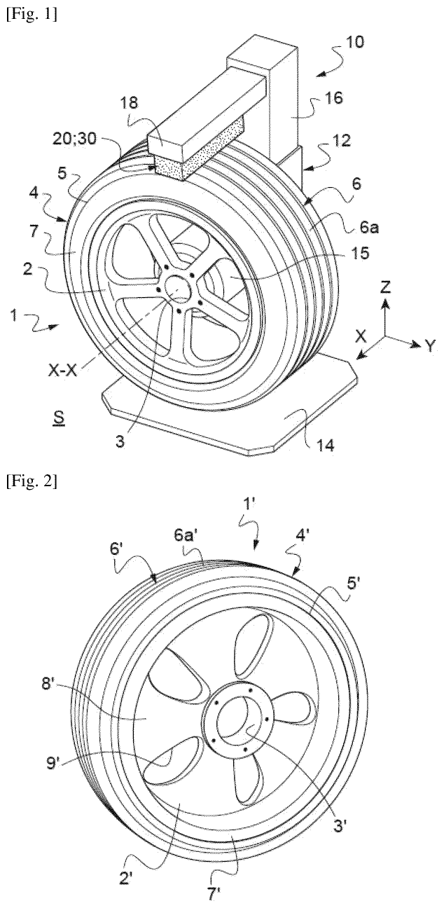

FIG. 1 very schematically shows a device for additive manufacturing of a tread according to the invention, configured to manufacture a tread on a tyre of a wheel according to a first embodiment;

FIG. 2 illustrates another example of a wheel on which the additive manufacturing device in FIG. 1 can be used;

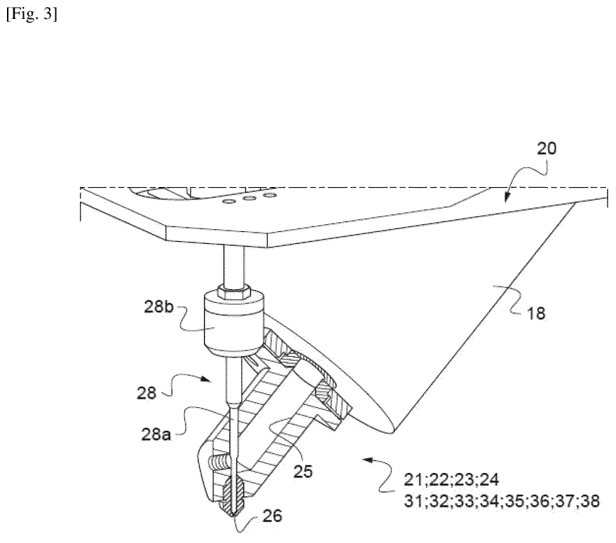

FIG. 3 illustrates a detail of a material-depositing nozzle of the additive manufacturing device in FIG. 1, comprising a temporary closing system according to one embodiment;

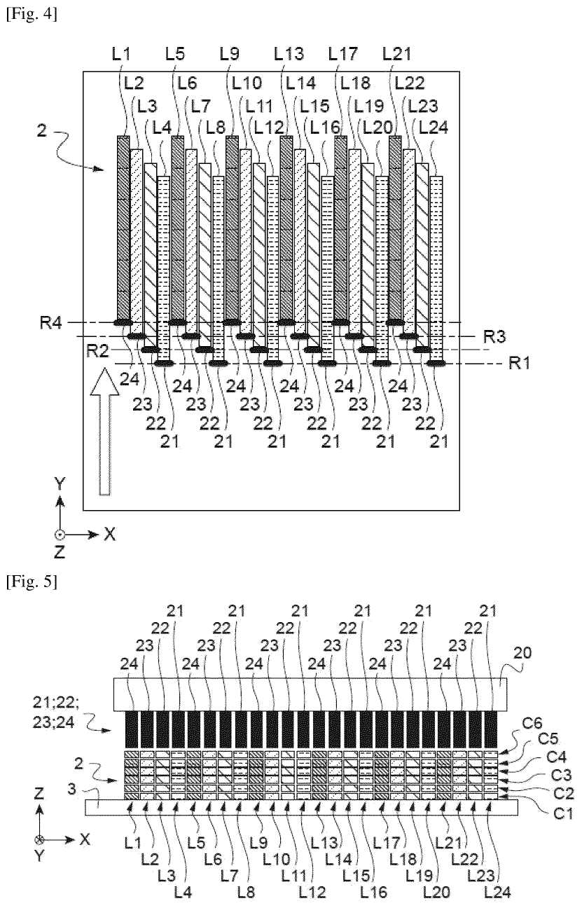

FIG. 4, FIG. 5 schematically show details of the device for additive manufacturing of a tread in FIG. 1, according to a first embodiment of the invention;

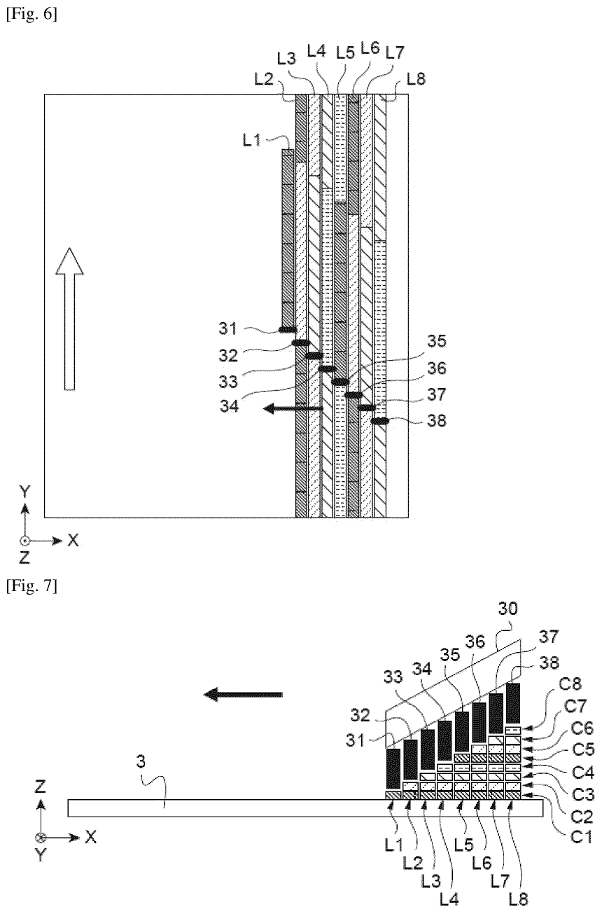

FIG. 6, FIG. 7 schematically show details of the device for additive manufacturing of a tread in FIG. 1, according to a second embodiment of the invention;

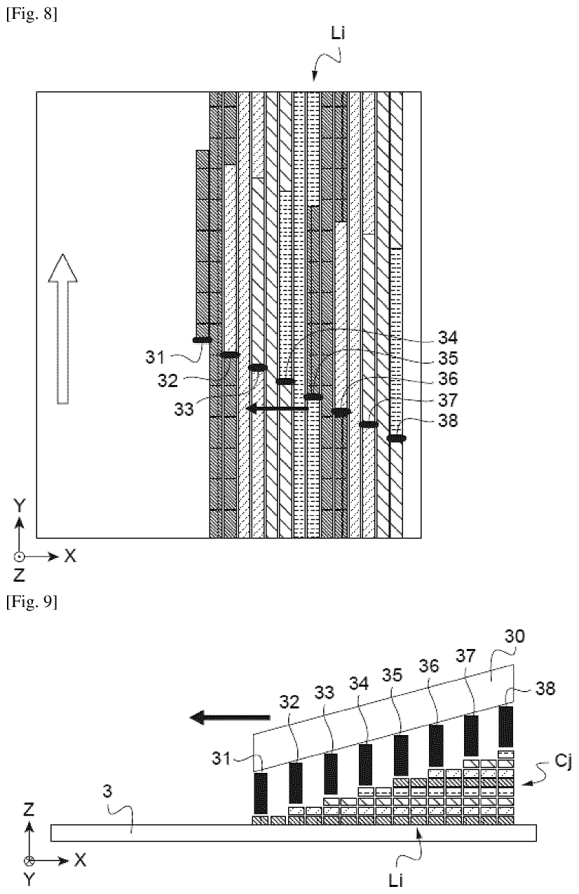

FIG. 8, FIG. 9 schematically show details of the device for additive manufacturing of a tread in FIG. 1, according to a third embodiment of the invention;

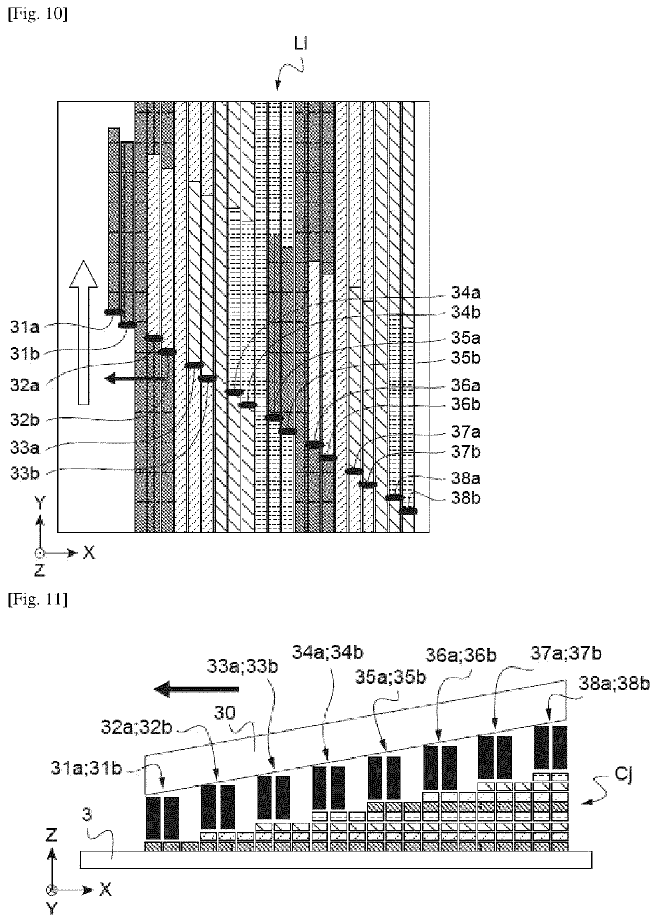

FIG. 10, FIG. 11 schematically show details of the device for additive manufacturing of a tread in FIG. 1, according to a fourth embodiment of the invention;

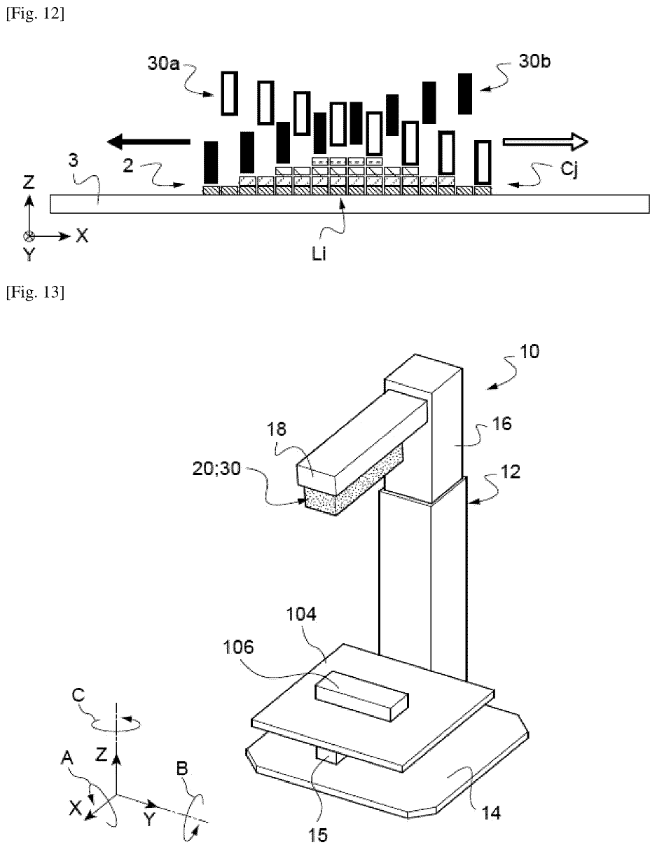

FIG. 12 schematically shows details of the device for additive manufacturing of a tread in FIG. 1 according to a fifth embodiment of the invention; and

FIG. 13 illustrates another example of a support on which the additive manufacturing device in FIG. 1 can be used.

The description below refers to an orthonormal coordinate system X, Y, Z defined relative to the additive manufacturing device 10, made up of:
a longitudinal axis X that is horizontal and extends from back to front in FIG. 1;
a transverse axis Y that is horizontal and perpendicular to the longitudinal axis X, and extends from left to right in FIG. 1; and
a vertical axis Z that is orthogonal to the longitudinal axis X and the transverse axis Y and extends from bottom to top in FIG. 1.

As illustrated in FIG. 1, a mounted assembly 1 or wheel comprises a rim 2 comprising a fastening hub 3 and a tyre 4 or pneumatic tyre mounted on the rim 2. The tyre 4 comprises a tread bearing surface 5, a tread 6 and two sidewalls 7 flanking the tread bearing surface 5, just one of which can be seen in FIG. 1.

The rim 2 is preferably the final rim intended to be mounted on a motor vehicle.

The fastening hub 3 forms the fastening interface between the wheel 1 and the vehicle.

Here, the fastening hub 3 defines a hollow fastening cylinder in which a wheel shaft (not shown) can be received.

Here, the tyre 4 is subject to internal pressure by means of an air chamber (not shown) inflated to a recommended nominal inflation pressure or less.

As a variant, the mounted assembly 1 could be a tubeless wheel comprising an insert (not shown) made up of a plurality of layers of expanded plastic to replace the air chamber.

The mounted assembly 1 could also be a so-called “airless” tyre.

The tread 6 comprises two lateral surfaces (not numbered), an inner surface (not shown) rigidly connected to the tread bearing surface 5 and a tread surface 6a opposite the inner surface and intended to come into contact with a roadway S when the wheel 1 is running.

The tread 6 comprises a plurality of cuts or tread patterns extending over at least one of its lateral surfaces.

Here, the rim 2 forms a radial bearing structure for the tyre 4.

As illustrated in FIG. 1, a device 10 for additive manufacturing of a tread 6 is configured to deposit an extruded material forming the tread 6 on a circumferential bearing surface 5 of the tyre 4 of the wheel 1.

Generally, the device 10 for additive manufacturing of a tread 6 is configured to deposit an extruded material forming the tread 6 on a tyre 4. Provision could be made for manufacturing a tread 6 on a tyre 4 not mounted on a wheel.

Provision could also be made for refilling a new tread 6 on a worn tread. In this instance, the bearing surface corresponds to the worn tread.

“Tyre” is given to mean all types of resilient tyre having a toric shape, subject to internal pressure or without internal pressure.

“Tread” of a tyre is given to mean a quantity of rubber material delimited by lateral surfaces and two main surfaces, one of which is called the tread surface and is intended to come into contact with a roadway when the tyre is running. The tread comprises a plurality of cuts or tread patterns extending over at least one of the lateral surfaces.

“Sidewall” of a tyre is given to mean part of the lateral surface of the tyre positioned between the tread of the tyre and a supporting structure of the wheel. In the case of a tyre of a conventional wheel, the sidewall starts from the ends of the cuts of the tread and extends to a bead of the tyre.

The additive manufacturing device 10 comprises a fixed stand 12 and one or more material-depositing rails 20, 30 translatably mounted relative to said fixed stand 12.

Non-limitingly, the fixed stand 12 comprises a base 14 fastened to the floor S and a vertical arm 16 for fastening the material-depositing rail 20, 30.

The material-depositing rail 20, 30 is positioned above the wheel 1, and in particular above the tread of the tyre 4.

The rail 20, 30 extends along an axis of extension, here the longitudinal axis X.

The additive manufacturing device 10 comprises an extruder 18 connected to the material-depositing rail 20, 30 and is configured to produce a thread of molten material, for example from pellets of material, preferably plastic, for example thermoplastic elastomer (TPE). The pellets of material are therefore hot extruded.

The thread of molten material is continuous.

Here, the extruder 18 is central and feeds said rail 20, 30 with a thread of molten material from pellets. In other words, the central extruder is associated with all of the material-depositing nozzles. As a variant, a position other than a central position could be envisaged for the single extruder.

As a variant, the central extruder 18 feeds said rail 20, 30 with a thread of molten material from one or more filaments, or even strips.

As a variant, at least one extruder associated with at least one material-depositing nozzle could be provided.

For example, a plurality of extruders could be provided, each associated with at least two material-depositing nozzles.

The tread 6 is manufactured by depositing extruded material layer by layer on the bearing surface 5 of the tyre 4. The extruded material melts on the previously deposited layer of 41 material and solidifies when the temperature drops.

To this end, the material-depositing rail 20, 30 comprises a plurality of nozzles 21, 22, 23, 24; 31, 32, 33, 34, 35, 36, 37, 38 that are described in detail with reference to FIGS. 3 to 12. Each of the nozzles is configured to deposit the molten material on the bearing surface 5 of the tyre 4 that is able to rotate about a horizontal axis of rotation X-X.

Additive manufacturing on a support, here the bearing surface 5 of the tyre 4, or more generally the tyre 4, that is continuously rotated, makes it possible to manufacture or rebuild the tread 6 entirely over its whole circumference.

“Continuous rotation” is given to mean rotation in a single sense of rotation, without interruption and at a constant speed.

“Discontinuous rotation” is given to mean rotation in a single sense of rotation, at a variable speed during the deposition of material.

To this end, the additive manufacturing device 10 comprises a member 15 for rotating the tyre 4 about the axis of rotation X-X.

As illustrated in FIG. 1, the rotation member 15 is in the form of a rotating drum or cylinder interacting with the wheel hub 3 and configured to rotate the tyre 4 via the wheel hub 3.

As a variant, provision could be made for the rotation member to comprise rollers positioned below the wheel in order to rotate said wheel by friction in the case of a tyre mounted on a wheel.

According to another variant, provision could be made for a rotation member configured to act directly on the sidewalls 7 of the tyre 4.

These variants are beneficial in the event that it is necessary to manufacture the tread 2 without removing the wheel 1 from the vehicle.

The additive manufacturing device 10 further comprises an actuation system (not shown) configured to move the material-depositing rail 20, 30 relative to the wheel 1 in a vertical direction Z and/or a longitudinal direction X parallel to the axis of rotation X-X across the width of the wheel 1. All of the nozzles are thus moved simultaneously at the same time as the movement of the material-depositing rail 20, 30.

The device 10 for additive manufacturing of a tread can also be used to manufacture or refill a tread 6′ on a bearing surface 5′ of a tyre 4′ of an integral wheel 1′ as illustrated in FIG. 2.

Here, the integral wheel 1′ comprises a radial bearing structure 2′ around which is fastened a solid tyre 4′ comprising a support 7′ radially outside the bearing structure 2′. The support 7′ extends over the whole circumference of the bearing structure 2′ and holds the tread 6′. Here, the tread 6′ is structurally incorporated into the support 7′ by means of a tread bearing surface 5′ forming a peripheral outer contour of the radial bearing structure 2′.

The solid tyre 4′ is not subject to internal pressure.

As illustrated in FIG. 2, the radial bearing structure 2′ comprises a fastening hub 3′ for fastening the wheel 1′ to a vehicle.

Here, the fastening hub 3′ defines a hollow fastening cylinder in which a wheel shaft (not shown) can be received.

The radial bearing structure 2′ is, for example, made from glass-fibre reinforced plastic.

Here, the bearing structure 2′ comprises a plurality of spokes or struts 8′ connecting the hub 3′ to the support 7′.

As illustrated in FIG. 2, the bearing structure 2′ comprises five spokes 8′. As a variant, a number of spokes 8′ between three and nine could be envisaged.

Openings or windows 9′ are defined between two adjacent spokes 8′. Here, the openings 9′ are evenly circumferentially distributed.

Here, the openings 9′ have oval profiles. As a variant, other shapes of profile of the openings 9′ could be envisaged.

Here, the bearing structure 2′ and the support 7′ comprise a three-dimensional beam or lattice network or structure.

As a variant, provision could be made for the radial bearing structure 2′ to comprise a plurality of vanes positioned radially to support the tyre 4′ and in particular the support 7′.

As illustrated in FIG. 3, each material-depositing nozzle or sprayer 21, 22, 23, 24; 31, 32, 33, 34, 35, 36, 37, 38 comprises a chamber 25 for receiving the molten material coming from the central extruder 18 and a dispensing orifice 26 communicating with the chamber 25.

The dispensing orifice 26 has a dimension of between 0.6 mm and 1.5 mm, preferably between 0.6 mm and 0.8 mm for producing a material deposit 1 mm wide, and preferably between 1 mm and 1.5 mm for producing a material deposit 2 mm wide.

The dispensing orifice 26 of each of the nozzles has a rectangular or circular cross-section. A rectangular cross-section makes it possible to improve the level of detail of the tread pattern and the quality of the interruptions.

Each of the material-depositing nozzles 21 to 24; 31 to 38 comprises a closing device 28 comprising closing means 28a that can be moved between a closed position and an open position of the dispensing orifice 26, and an actuator 28b for controlling the movement of the closing means 28a between the closed and open positions. The closing means 28a are controllable independently of each other.

Each nozzle thus comprises its own closing means 28 configured to interrupt the flow of molten material through the dispensing orifice 26 of the corresponding nozzle.

Each of the nozzles can be interrupted independently and responsively, so as to generate any tread pattern or geometry on the wheel 1 in a short time, preferably less than 20 minutes, preferably less than 15 minutes.

Such a filling duration corresponds to a material deposition rate of between 10 kg/hr and 20 kg/hr, preferably equal to 12 kg/hr.

The closing frequency is between 10 Hz and 30 Hz, for example equal to 20 Hz.

In the example illustrated in FIG. 3, the closing means 28a are in the form of a needle actuated by the actuator 28b.

The actuator 28b comprises, for example, a piezoelectric device (not shown) for closing or opening the dispensing orifice 26 of the corresponding nozzle.

The needle closing means 28a make it possible to produce clean stoppages of the flow of molten material, without burrs, and clear resumptions of said flow.

As a variant, any other closing means associated with each of the nozzles could be provided, such as a valve for example.

According to one non-limiting example, the additive manufacturing device 10 can comprise a volumetric metering device (not shown) positioned downstream of the central extruder and upstream of the material-depositing rail 20, 30.

For example, the volumetric metering device is a gear pump. The volumetric metering device is configured to deposit a calibrated quantity of molten material onto the bearing surface 5, 5′ of the tyre 4, 4′. Lines of material having a constant width can thus be obtained, unlike during material deposition in the form of series of droplets known in the prior art.

The terms “downstream” and “upstream” are defined with respect to the direction of circulation of the material.

An example of a material-depositing rail 20 is illustrated with reference to FIGS. 4 and 5.

In this example, the material-depositing rail 20 is configured to deposit extruded material forming the tread 6, 6′ on the tyre 4, 4′, in particular the circumferential bearing surface 5, 5′ thereof, in circumferential lines of material Li.

Depositing material in a “circumferential line of material” Li is given to mean depositing material on a circular path of the tyre 4, 4′, where i ranges from 1 to x, x being the total number of lines of material.

“Layer of material” Cj is given to mean all of the circumferential or transverse lines of material Li side by side across the whole width of the tread 6, 6′ to be manufactured, where j ranges from 1 to y, y being the total number of layers of material for forming the total thickness of the desired tread 6, 6′.

A layer of material C corresponds to a thickness of deposited molten material.

“Row” R is given to mean an arrangement along the longitudinal axis X parallel to the axis of rotation X-X of the tyre 4, 4′ and perpendicular to the vertical direction Z. A row R is positioned across the width of the tyre 4, 4′, in particular of its bearing surface 5, 5′.

As illustrated in FIGS. 4 and 5, the material-depositing rail 20 comprises a plurality of material-depositing nozzles 21, 22, 23, 24, here twenty-four in number, each intended to build all of the thicknesses or strata of at least one circumferential line of material Li.

“Thickness” is given to mean a stratum of deposited material on a line of material.

As illustrated, here, the number of material-depositing nozzles is twenty-four and the number of lines of material Li is also equal to twenty-four. Therefore, i is between one and twenty-four.

As a variant, a different number of material-depositing nozzles could be provided.

As illustrated, here, the number of layers of material Cj is six. Therefore, j is between one and six.

As a variant, a different number of layers of material Cj could be provided.

As illustrated, the material-depositing rail 20 has a width at least equal to the width of the tread 6, 6′ to be manufactured.

During the continuous rotation of the wheel 4, 4′ below the material-depositing rail 20, each of the material-depositing nozzles is actuated in order to deposit material on a given circumferential line of material Li. The first nozzle 24 deposits material on a first line L1, the second nozzle 23, adjacent to the first nozzle 24, simultaneously deposits material on a second line L2, adjacent to the first line L1, and so on until the entire layer comprising all of the adjacent circumferential lines Li is produced.

An entire layer is thus produced on each complete rotation of the tyre 4, 4′. After each complete rotation of the tyre, the material-depositing rail 20 is translated relative to the tyre 4, 4′ along the vertical axis Z, and each of the material-depositing nozzles 21, 22, 23, 24 is actuated in order to deposit molten material in the same given circumferential line of material Li, in order to form the second layer. These operations are repeated until the desired thickness of the tread 6, 6′ is obtained.

In the example illustrated in FIGS. 4 and 5, a single material-depositing nozzle 21, 22, 23, 24 is configured to build all of the thicknesses of a given circumferential line of material Li.

Here, the material-depositing nozzles 21, 22, 23, 24 are arranged on the material-depositing rail 20 in rows R1, R2, R3, R4 offset along the transverse axis Y.

It can in fact be necessary to provide a distance of 4 mm between each material-depositing nozzle.

As illustrated, the material-depositing rail comprises four rows R1, R2, R3, R4 each comprising six material-depositing nozzles 21, 22, 23, 24. As a variant, a different number of rows could be provided, for example greater than or equal to two. A different number of nozzles per row R could also be provided.

The number of rows R depends on the width of the tread 6, 6′ to be manufactured.

As a variant, provision could also be made for the material-depositing nozzles 21, 22, 23, 24 to be arranged on the material-depositing rail 20 in a single row R1 in the longitudinal direction X.

As a variant, provision could be made for the material-depositing rail 20 to have a different width from the tread 6, 6′ to be manufactured.

For example, provision could be made for the material-depositing rail 20 to have a smaller width than the width of the tread 6, 6′ to be manufactured. In this instance, on each complete rotation of the tyre 4, 4′, each material-depositing nozzle 21 to 24 deposits material over a thickness in a given circumferential line of material Li, and after each complete turn of the tyre 4, 4′, the material-depositing rail 20 is axially translated relative to the tyre 4, 4′ along the longitudinal axis X by the width of said rail 20, as many times as necessary to manufacture the first layer comprising all of the lines of material Li. After the manufacturing of each layer comprising all of the lines of material Li, the material-depositing rail 20 is translated relative to the tyre 4, 4′ along the vertical axis Z and the operation to manufacture a layer is repeated.

These operations are repeated until all of the superposed layers forming the desired thickness of the tread 6, 6′ are obtained.

For example, for a bearing surface 5, 5′ having a width of 225 mm, and a material-depositing rail 20 that is 80 mm wide, the tyre 4, 4′ is rotated over three complete turns and on each complete turn, the material-depositing rail 20 is offset along the longitudinal axis X by 80 mm.

Each material-depositing nozzle 21, 22, 23, 24 thus deposits material on a plurality of given circumferential lines of material Li during a plurality of complete turns of the tyre 4, 4′.

According to another variant, provision could be made for the width of the material-depositing rail 20 to be equal to or greater than the width of the tread 5, 5′ to be manufactured, or more generally than the width of the bearing surface 5, 5′, but for the density of material-depositing nozzles to be reduced in order to reduce costs. In this instance, after each complete turn of the tyre 4, 4′, the material-depositing rail 20 is axially offset in translation relative to the tyre 4, 4′ along the longitudinal axis X by the width of a material-depositing nozzle 21, 22, 23, 24 as many times as necessary to produce the first layer C1 comprising all of the lines of material Li. After the manufacturing of each layer comprising all of the lines of material Li, the material-depositing rail 20 is translated relative to the tyre 4, 4′ along the vertical axis Z and the operation to manufacture a layer is repeated.

These operations are repeated until all of the superposed layers forming the desired thickness of the tread 6, 6′ are obtained.

Again, each material-depositing nozzle deposits material on a plurality of lines of material during a plurality of complete turns of the tyre 4, 4′.

However, such a variant increases the total manufacturing time of the tread.

As illustrated, the additive manufacturing device 10 comprises a single material-depositing rail 20 around the tyre 4, 4′.

As a variant, provision could be made for the additive manufacturing device 10 to comprise at least two material-depositing rails 20 each associated with a dedicated actuation system and arranged circumferentially around the tyre at two given azimuths.

For example, a first rail at a first given azimuth and a second rail positioned at 180° to the first rail could be provided. As a variant, provision could be made for the second rail to be positioned relative to the first rail at an angle of between 10° and 350°, preferably between 30° and 320°.

As a variant, a different number(of rails could be provided, for example greater than or equal to three, each associated with a dedicated actuation system and arranged circumferentially around the tyre at three given azimuths.

Another example of a material-depositing rail 30 is illustrated with reference to FIGS. 6 and 7.

In this example, the material-depositing rail 30 is configured to deposit extruded material forming the tread 6, 6′ on the tyre 4, 4′, in particular the circumferential bearing surface 5, 5′ thereof, in layers of material Cj.

In this example, the width of the material-depositing rail 30, 30a, 30b is equal to the width of the tread 6, 6′ to be manufactured and each material-depositing nozzle 31 to 38 is configured to build an entire layer of material Cj.

On each complete rotation of the tyre, one of the material-depositing nozzles of the material-depositing rail 30 deposits material on a circumferential line of material Li of a layer of material Cj. After each complete rotation of the tyre 4, 4′, the material-depositing rail 30 is translated axially only relative to the tyre 4, 4′ along the longitudinal axis X by a line of material Li. These operations are repeated until each material-depositing nozzle 31 to 38 deposits material on an entire layer of material Cj comprising all of the lines o material Li.

In other words, during a complete rotation of the tyre 4, 4′, the nozzles 31 to 38 are actuated in succession in order to manufacture a given circumferential line of material Li. The first nozzle 31 deposits material on a first line L8 over a first thickness, then the material-depositing rail 30 is moved axially relative to the tyre 4, 4′ along the longitudinal axis X by the width of a line of material Li, the first nozzle 31 deposits material on a second line L7 and the second nozzle 32, adjacent to the first nozzle 31, deposits material on the first line L8 over a second layer thickness superposed on the first line formed by the first nozzle, and so on until each material-depositing nozzle manufactures a given layer Cj until the desired tread pattern of the tread 6, 6′ is obtained.

The first material-depositing nozzle 31 thus produces the first layer C1, the second nozzle 32 produces the second layer C2, the third nozzle 33 produces the third layer C3, and so on until the desired total thickness of the tread 6, 6′ is obtained. Each of the material-depositing nozzles 31 to 38 is therefore configured to build an entire layer of material Cj.

The layers Cj are thus built one turn behind the preceding layer.

Such an arrangement makes it possible to use fewer material-depositing nozzles than depositing material with nozzles configured to deposit the material in a line of material Li.

In this embodiment, the material-depositing rail 30 is not translated along the vertical axis Z.

This time, the number of material-depositing nozzles 31 to 38 depends on the number of layers of material to be built.

Here, the material-depositing nozzles 31 to 38 are positioned in rows R1, R2, R3, R4 offset along the vertical axis Z.

It can in fact be necessary to provide a distance of 4 mm between each material-depositing nozzle.

As illustrated, the material-depositing rail comprises eight material-depositing nozzles 31 to 38. As a variant, a different number of material-depositing nozzles could be provided, for example greater than or equal to six.

As illustrated, the number of lines of material Li is equal to eight. As a variant, a different number of lines of material Li could be provided. The number of lines of material depends on the width of the tread 6, 6′ to be manufactured.

As illustrated, the number of layers of material Cj is equal to eight. As a variant, a different number of layers of material Cj could be provided. The number of layers of material Cj depends on the total thickness of the tread 6, 6′ to be manufactured.

Taking for example a thickness of 0.8 mm of a layer Cj for a total thickness of 8 mm of the tread to be manufactured, ten material-depositing nozzles can be used.

However, the rotating speed of the tyre 4, 4′ and the closing frequency of the nozzles are higher than with nozzles configured to deposit the material in a line of material Li, as described in detail with reference to FIGS. 3 and 4.

In the example illustrated in FIGS. 6 and 7, the material-depositing nozzles 31 to 38 deposit material on the same line of material Li with an offset along the longitudinal axis X.

As illustrated, the nozzles 31 to 38 are also offset along the vertical axis Z, such that it is no longer necessary to move the material-depositing rail vertically relative to the tyre 4, 4′.

The embodiment illustrated in FIGS. 8 and 9, in which the same elements bear the same reference signs, differs from the embodiment illustrated in FIGS. 6 and 7 solely in that the layers Cj are built two turns behind the preceding layer.

As illustrated in FIGS. 8 and 9, the material-depositing rail 30 comprises eight material-depositing nozzles 31 to 38. As a variant, a different number of material-depositing nozzles could be provided, for example greater than or equal to six.

As illustrated, the number of lines of material Li is equal to fifteen. As a variant, a different number of lines of material Li could be provided. The number of lines of material depends on the width of the tread 6, 6′ to be manufactured.

As illustrated, the number of layers of material Cj is equal to eight. As a variant, a different number of layers of material Cj could be provided. The number of layers of material Cj depends on the total thickness of the tread 6, 6′ to be manufactured.

The embodiment illustrated in FIGS. 10 and 11, in which the same elements bear the same reference signs, differs from the embodiment illustrated in FIGS. 8 and 9 solely in that two material-depositing nozzles 31a, 31b to 38a, 38bare configured to build an entire layer of material comprising all of the adjacent circumferential lines Li over a thickness. The layers of material Cj are built two turns behind the preceding layer.

As illustrated in FIGS. 10 and 11, the material-depositing rail 30 comprises sixteen material-depositing nozzles 31a, 31bto 38a, 38b. As a variant, a different number of material-depositing nozzles could be provided, for example greater than or equal to eight.

As illustrated, the number of lines of material is equal to twenty-three. As a variant, a different number of lines of material could be provided. The number of lines of material depends on the width of the tread 6, 6′ to be manufactured.

As illustrated, the number of layers of material Cj is equal to eight. As a variant, a different number of layers of material Cj could be provided. The number of layers of material Cj depends on the total thickness of the tread 6, 6′ to be manufactured.

The embodiment illustrated in FIG. 12, in which the same elements bear the same reference signs, differs from the embodiment illustrated in FIGS. 8 and 9 solely in that the additive manufacturing device 10 comprises two material-depositing rails 30a, 30b.

The additive manufacturing device 10 comprises a first actuation system (not shown) configured to translate a first material-depositing rail 30a relative to the tyre 4, 4′ in the longitudinal direction X parallel to the axis of rotation X-X across the width of the tyre 4, 4′ in a first sense.

The additive manufacturing device 10 comprises a second actuation system (not shown) configured to translate a second material-depositing rail 30b relative to the wheel 1, 1′ in a second sense in the longitudinal direction X across the width of the tyre 4, 4′.

The first sense is opposite to the second sense.

The two material-depositing rails 30a, 30b are thus configured to be moved along the longitudinal axis X relative to the tyre 4, 4′ in opposite senses starting from the middle of the tyre 4, 4′. The two material-depositing rails 30a, 30b are configured to deposit material on a single layer Cj together.

Each rail 30a, 30b corresponds to one of the rails described with reference to FIGS. 6 to 11.

As illustrated in FIG. 12, each material-depositing rail 30a, 30b comprises eight material-depositing nozzles (not numbered). As a variant, a different number of material-depositing nozzles could be provided, for example greater than or equal to six.

As illustrated, the number of lines of material Li is equal to sixteen. As a variant, a different number of lines of material could be provided. The number of lines of material depends on the width of the tread 6, 6′ to be manufactured.

As illustrated, the number of layers of material Cj is equal to four. As a variant, a different number of layers of material Cj could be provided. The number of layers of material Cj depends on the total thickness of the tread 6, 6′ to be manufactured.

In the embodiments illustrated in FIGS. 1 to 12, the additive manufacturing device 10 has been described with respect to manufacturing a tread 6, 6′ of a tyre 4, 4′.

However, the present invention is not limited to manufacturing a tread of a tyre. The additive manufacturing device 10 is in fact configured to manufacture any type of three-dimensional object having a cylindrical shape or a shape other than cylindrical, for example parallelepipedal.

Reference can be made in this regard to FIG. 13, which illustrates a manufacturing support 104 for a three-dimensional object 106, here a rectangular parallelepiped.

Here, the manufacturing support 104 is in the form of a platform extending in the plane XY comprising the longitudinal axis X and the transverse axis Y. The platform 104 comprises an outer bearing surface (not numbered) for receiving the successive layers Cj of extruded material coming from the rail 20, 30 of the additive manufacturing device 10 and forming the manufactured three-dimensional object 106.

As a variant, a flat shape other than parallelepipedal could be envisaged for the platform 104.

The object 106 to be manufactured can be manufactured using one or more material-depositing rails 20 as described in detail with reference to FIGS. 4 and 5 or using one or more material-depositing rails 30, 30a, 30b as described in detail with reference to FIGS. 6 to 11.

Generally, the manufacturing support 104 and the one or more rails 20, 30, 30a, 30b of the additive manufacturing device 10 undergo a relative movement with respect to each other at least in the longitudinal direction X and/or the vertical direction Z.

The additive manufacturing device 10 comprises a member 15 for driving the manufacturing support 104 at least in translation, capable of translating the manufacturing support 104 at least in a working direction, here along a transverse axis Y.

Generally, the working direction of the manufacturing support 104 is perpendicular to the axis of extension, here the longitudinal axis X, of the rail 20, 30.

Similarly to in the embodiments illustrated in FIGS. 4 to 11, the additive manufacturing device 10 further comprises an actuation system (not shown) configured to generate a relative translation of the material-depositing rail 20, 30 with respect to the manufacturing support 104 in a vertical direction Z and/or a longitudinal direction X. When the material-depositing rail 20, 30 is moved, all of the material-depositing nozzles are thus moved simultaneously at the same time as the movement of the material-depositing rail 20, 30.

Here, the longitudinal direction is parallel to the longitudinal axis X of the rail 20, 30 or can be coincident with said longitudinal axis X.

“Width” of the object 106 to be manufactured is given to mean the dimension along the longitudinal axis X. The width could also be the dimension along the transverse axis Y. Generally, the width of the object 106 to be manufactured corresponds to the dimension of extension, here the longitudinal axis X, of the rail 20, 30. If the object 106 is manufactured by the plurality of material-depositing nozzles 21, 22, 23, 24 of the material-depositing rail 20 described in detail with reference to FIGS. 4 and 5, each of said nozzles 21 to 24 is intended to build all of the thicknesses or strata of at least one given transverse line of material Li.

According to one embodiment, the material-depositing rail 20 has a width equal to the width of the object 106 to be manufactured.

Each of the material-depositing nozzles is actuated in order to deposit material on a given transverse line of material Li. The first nozzle 24 deposits material on a first line L1, the second nozzle 23, adjacent to the first nozzle 24, simultaneously deposits material on a second line L2, adjacent to the first line L1, and so on until the entire layer comprising all of the adjacent transverse lines Li is produced.

After each layer of material Cj is manufactured, corresponding to a material deposition sequence, the material-depositing rail 20 is translated relative to the manufacturing support 104 along the vertical axis Z, and each of the material-depositing nozzles 21, 22, 23, 24 is actuated in order to deposit molten material in the same given transverse line of material Li, in order to form the second layer. These operations are repeated until the desired thickness of the object 106 to be manufactured is obtained.

The material-depositing rail 20 can be able to translate relative to the manufacturing support 104 along the vertical axis Z. As a variant, the material-depositing rail 20 can be fixed relative to the stand 12 of the manufacturing device 10, and the manufacturing support 104 is able to translate relative to the material-depositing rail 20 along the vertical axis Z.

The manufacturing support 104 and the rail 20 of the additive manufacturing device 10 advantageously undergo a relative movement with respect to each other at least in the working direction, here the transverse direction Y.

Again, provision can be made for the material-depositing rail 20 to be able to translate relative to the manufacturing support 104 along the transverse axis Y or, as a variant, for the manufacturing support 104 to be able to translate relative to the material-depositing rail 20 along the transverse axis Y.

During the relative movement in the transverse direction Y of the material-depositing rail 20 relative to the manufacturing support 104, each of the material-depositing nozzles is actuated in order to deposit material on a given transverse line of material Li. The first nozzle 24 deposits material on a first line L1, the second nozzle 23, adjacent to the first nozzle 24, simultaneously deposits material on a second line L2, adjacent to the first line L1, and so on until the entire layer comprising all of the adjacent transverse lines Li is produced.

After the manufacturing of each layer of material Cj, corresponding to a material deposition sequence, the transverse position of the manufacturing support 104 is reset and a relative movement along the vertical axis Z of the material-depositing rail 20 with respect to the manufacturing support 104 is generated in order to move said rail 20 vertically away from said support 104. Then, each of the material-depositing nozzles 21, 22, 23, 24 is actuated in order to deposit molten material in the same given transverse line of material Li, in order to form the second layer. These operations are repeated until the desired thickness of the object 106 to be manufactured is obtained.

Again, provision can be made for the material-depositing rail 20 to be able to translate relative to the manufacturing support 104 along the vertical axis Z or, as a variant, for the manufacturing support 104 to be able to translate relative to the material-depositing rail 20 along the vertical axis Z.

In other words, during each material deposition sequence, the manufacturing support is translated relative to the material-depositing rail along the transverse axis between an initial position and a final position, and returns to its initial position at the end of each material deposition sequence.

Again, it can also be envisaged that the position of the manufacturing support not be reset and that material be deposited on the deposited layer of material in the opposite sense.

It can in fact be envisaged that it does not return to the initial position in order to deposit material on the next layer, but starts in the final position of the preceding layer and creates the layer in the opposite sense. This makes it possible to save time and does not require time for returning to the initial position.

According to another embodiment, the material-depositing rail 20 has a smaller width than the width of the object 106 to be manufactured.

In this instance, during the relative movement in the transverse direction Y of the material-depositing rail 20 with respect to the manufacturing support 104, each material-depositing nozzle 21 to 24 deposits material over a thickness in a given transverse line of material Li, and after each manufacturing of thickness in a given transverse line of material Li, corresponding to a material deposition sequence, the material-depositing rail 20 is translated axially relative to the manufacturing support 104 along the longitudinal axis X by the width of said rail 20, as many times as necessary to manufacture the first layer comprising all of the lines of material Li. These operations are repeated until all of the superposed layers forming the desired thickness of the object 106 to be manufactured are obtained.

An entire layer is thus produced on each material deposition sequence.

After the manufacturing of each layer of material Cj, corresponding to a material deposition sequence, the transverse position of the manufacturing support 104 is reset and a relative movement along the vertical axis Z of the material-depositing rail 20 with respect to the manufacturing support 104 is generated in order to move said rail 20 vertically away from said support 104, and the operation to manufacture a layer is repeated.

“Initial transverse position” of the manufacturing support 104 is given to mean the first transverse position of the manufacturing support 104 relative to the material-depositing rail 20, 30 in which material is deposited for the first time on said manufacturing support 104.

If the object 106 is manufactured by the plurality of material-depositing nozzles 31 to 38 of the material-depositing rail 30 described in detail with reference to FIGS. 6 and 7, the width of the material-depositing rail 30, 30a, 30b is equal to the width of the object 106 to be manufactured and each material depositing nozzle 31 to 38 is configured to build an entire layer of material Cj.

During a relative movement in the working direction, here the transverse direction Y, of the material-depositing rail 30 with respect to the manufacturing support 104, one of the material-depositing nozzles of the material-depositing rail 30 deposits material on a transverse line of material Li of a layer of material Cj and, after each material deposition sequence, the material-depositing rail 30 is translated axially relative to the manufacturing support 104 along the longitudinal axis X by a line of material Li and the manufacturing support 104 is moved to its initial transverse position. These operations are repeated until each material-depositing nozzle 31 to 38 deposits material on an entire layer of material Cj comprising all of the transverse lines of material Li.

Provision can be made for the material-depositing rail 30 to be able to translate relative to the manufacturing support 104 along the working axis, here the transverse axis Y or, as a variant, for the manufacturing support 104 to be able to translate relative to the material-depositing rail 30 along the working axis, here the transverse axis Y.

Provision can be made for the material-depositing rail 30 to be able to translate relative to the manufacturing support 104 along the longitudinal axis X or, as a variant, for the manufacturing support 104 to be able to translate relative to the material-depositing rail 30 along the longitudinal axis X.

In other words, during a relative movement in the working direction, here the transverse direction Y, of the material-depositing rail 30 with respect to the manufacturing support 104, the material-depositing nozzles 31 to 38 are actuated in succession in order to manufacture a given transverse line of material Li. The first nozzle 31 deposits material on a first line L8 over a first thickness, corresponding to a first material deposition sequence, then the material-depositing rail 30 is moved axially relative to the manufacturing support 104 along the longitudinal axis X by the width of a line of material Li, the first nozzle 31 deposits material on a second line L7 and the second nozzle 32, adjacent to the first nozzle 31, deposits material on the first line L8 over a second layer thickness superposed on the first line formed by the first nozzle, corresponding to a second material deposition sequence, and so on until each material-depositing nozzle manufactures a given layer Cj until the desired geometry of the object 106 to be manufactured is obtained.

The first material-depositing nozzle 31 thus produces the first layer C1, the second nozzle 32 produces the second layer C2, the third nozzle 33 produces the third layer C3, and so on until the desired total thickness of the object 106 to be manufactured is obtained. Each of the material-depositing nozzles 31 to 38 is therefore configured to build an entire layer of material Cj.

After each material deposition sequence, the manufacturing support is translated relative to the material-depositing rail along the transverse axis to its initial position.

Such an arrangement makes it possible to use fewer material-depositing nozzles than depositing material with nozzles configured to deposit the material in a line of material Li.

This time, the number of material-depositing nozzles 31 to 38 depends on the number of layers of material to be built.

Here, the material-depositing nozzles 31 to 38 are arranged in rows R1, R2, R3, R4 offset along the vertical axis Z, such that it is no longer necessary to move the material-depositing rail 30 vertically relative to the manufacturing support 104.

In the example illustrated in FIGS. 6 and 7, the material-depositing nozzles 31 to 38 deposit material on the same line of material Li with an offset along the longitudinal axis X.

If the object 106 is manufactured by the plurality of material-depositing nozzles 31 to 38 of the material-depositing rail 30 described in detail with reference to FIGS. 8 and 9, the layers Cj are built two turns behind the preceding layer.

If the object 106 is manufactured by the plurality of material-depositing nozzles 31 to 38 of the material-depositing rail 30 described in detail with reference to FIGS. 10 and 11, two material-depositing nozzles 31a, 31b to 38a, 38b are configured to build an entire layer of material comprising all of the adjacent transverse lines Li over one thickness. The layers of material Cj are built two turns behind the preceding layer.

If the object 106 is manufactured by the material-depositing rails 30a, 30b described in detail with reference to FIG. 12, the additive manufacturing device 10 comprises a first actuation system (not shown) configured to translate a first material-depositing rail 30a relative to the manufacturing support 104 in the longitudinal direction X parallel to the axis of rotation X-X across the width of the manufacturing support 104 in a first sense.

The additive manufacturing device 10 comprises a second actuation system (not shown) configured to translate a second material-depositing rail 30b relative to the manufacturing support 104 in a second sense in the longitudinal direction X.

The first sense is opposite to the second sense.

The two material-depositing rails 30a, 30b are thus configured to be moved along the longitudinal axis X relative to the manufacturing support 104 in opposite senses starting from a transverse mid-plane of the manufacturing support 104. The two material-depositing rails 30a, 30b are configured to deposit material on a single layer Cj together.

Each rail 30a, 30b corresponds to one of the rails described with reference to FIGS. 6 to 11.

Generally, the manufacturing support 104 and the one or more rails 20, 30, 30a, 30b of the additive manufacturing device 10 undergo a relative movement with respect to each other at least in the longitudinal direction X and/or the vertical direction Z.

Preferably, the manufacturing support 104 is able to translate along the working axis, here the transverse axis Y.

Generally, provision could be made for the manufacturing support 104 to be movable relative to the rail 20, 30 of the additive manufacturing device 10 along one to three axes of movement, namely the vertical axis Z, the longitudinal axis X and the transverse axis Y.

As a variant, provision could be made for the manufacturing support 104 to be fixed relative to the stand 12 of the manufacturing device 10.

If the manufacturing support 104 is movable at least along the vertical axis Z and/or along the longitudinal axis X, the rail 20, 30 of the additive manufacturing device 10 can be fixed relative to the fixed stand 12 of said device 10.

In all of the embodiments, provision could also be made for the manufacturing platform 104 to be movable relative to the rail 20, 30, 30a, 30b about one to three axes of rotation A, B, C respectively defined around the axes X, Y and Z.

In all of the embodiments, provision could be made for the closing means of certain nozzles to be in the closed position in order to produce a particular geometric shape of the object to be manufactured.

The multi-nozzle material-depositing rail makes it possible to deposit material in selected locations and thus produce a high-quality geometry of the three-dimensional object, namely a tread, a cylindrical object or any other object, for example having a parallelepipedal shape.

1.-13. (canceled)

14. A device for additive manufacturing of all or part of a three-dimensional object on a manufacturing support, the device comprising:
at least one additive material-depositing rail intended to be positioned above the manufacturing support, extending along a longitudinal axis and comprising a plurality of material-depositing nozzles, each provided with at least one dispensing orifice,
each of the material-depositing nozzles comprising closing means that can be moved between a closed position and a plurality of open positions of the at least one dispensing orifice, and an actuator for controlling movement of the closing means between the closed and open positions,
the closing means being controllable independently of each other;
one actuation system configured to generate a relative translation of the at least one additive material-depositing rail with respect to the manufacturing support in at least a vertical direction and/or a longitudinal direction; and
a drive member of the manufacturing support capable of driving the manufacturing support in a working direction perpendicular to the longitudinal direction,
wherein the material-depositing nozzles of the at least one additive material-depositing rail are arranged in a single plane comprising the longitudinal axis perpendicular to the working direction, the material-depositing nozzles being vertically offset relative to each other.

15. The device according to claim 14, further comprising at least one extruder connected to the at least one additive material-depositing rail and feeding the at least one additive material-depositing rail with a thread of molten material.

16. The device according to claim 15, wherein the at least one extruder is central and associated with all of the material-depositing nozzles.

17. The device according to claim 15, comprising a plurality of extruders, each associated with at least two material-depositing nozzles.

18. The device according to claim 15, wherein each material-depositing nozzle comprises a chamber for receiving molten material coming from the at least one extruder communicating with the dispensing orifice.

19. The device according to claim 14, wherein the dispensing orifice of each of the material-depositing nozzles has a rectangular or circular cross-section.

20. The device according to claim 14, wherein each of the closing means comprises a needle.

21. The device according to claim 14, wherein the material-depositing nozzles are arranged on the at least one additive material-depositing rail in a single row in the longitudinal direction.

22. The device according to claim 14, wherein the material-depositing nozzles are arranged on the at least one additive material-depositing rail in at least two parallel rows offset along a transverse axis perpendicular to the longitudinal direction and perpendicular to the vertical direction, each row comprising at least two material-depositing nozzles aligned in the longitudinal direction.

23. The device according to claim 14, comprising two additive material-depositing rails, each associated with a dedicated actuation system, the two material-depositing rails being able to translate in two opposite senses in the longitudinal direction.

24. The device according to claim 14, wherein the actuation system is configured to translate the at least one additive material-depositing rail relative to the manufacturing support in a vertical direction and/or the longitudinal direction.

25. A method for additive manufacturing of all or part of a three-dimensional object on a manufacturing support using a manufacturing device comprising at least one material-depositing rail positioned above the manufacturing support, extending along a longitudinal axis and comprising a plurality of additive material-depositing nozzles, each provided with at least one dispensing orifice, the additive material-depositing nozzles of the at least one material-depositing rail being arranged in a single plane comprising a longitudinal axis perpendicular to a working direction, the additive material-depositing nozzles being vertically offset relative to each other, the method comprising the following steps:
a material deposition sequence during which each of the additive material-depositing nozzles deposits extruded material on the manufacturing support;
independently controlling closing means associated with each of the additive material-depositing nozzles in order to move between a closed position and a plurality of open positions of the dispensing orifice of each additive material-depositing nozzle depending on a geometry of the three-dimensional object to be manufactured, and during each material deposition sequence, translating the manufacturing support relative to the at least one material-depositing rail along a transverse axis between an initial position and a final position; and
after each material deposition sequence, causing the at least one material-depositing rail and the manufacturing support to undergo relative translation with respect to each other in at least a vertical direction and/or a longitudinal direction,
wherein a width of the at least one material-depositing rail is smaller than a width of the three-dimensional object to be manufactured,
wherein, during each material deposition sequence, each additive material-depositing nozzle deposits material over a thickness in a given line of material,
wherein the at least one material-depositing rail is translated axially relative to the manufacturing support along the longitudinal axis by the width of the at least one material-depositing rail after each material deposition sequence, and
wherein the steps are repeated until a first layer of material comprising all lines of material is obtained.

26. The method according to claim 25, wherein during each material deposition sequence, each additive material-depositing nozzle deposits material over a thickness of at least one given line of material, and all of the additive material-depositing nozzles deposit material in a first layer corresponding to the width of the three-dimensional object to be manufactured,
wherein after each material deposition sequence, the at least one material-depositing rail is translated relative to the manufacturing support along the vertical axis and each of the additive material-depositing nozzles deposits material in the same given line of material, in order to form a second layer superposed on the first layer, and
wherein the steps are repeated until a desired thickness of the three-dimensional object is obtained.
